(19) United States
(12) Patent Application Publication
(10) Pub. No.: US 2025/0269701 A1
(43) Pub. Date: Aug. 28, 2025

(54) GLAZING SYSTEM AND METHOD FOR LIGHT OUTCOUPLING A MATERIAL

(71) Applicant: AGP WORLDWIDE OPERATIONS GMBH, Zug (CH)

(72) Inventors: Alexey KRASNOV, Canton, MI (US); José NUÑEZ REGUEIRO, Novi, MI (US); Charles VOELTZEL, Shelby Township, MI (US)

(21) Appl. No.: 18/704,046

(22) PCT Filed: Oct. 26, 2022
(86) PCT No.: PCT/IB2022/060314

§ 371 Date: Apr. 23, 2024

Related U.S. Application Data
(60) Provisional application No. 63/263,079, filed on Oct. 26, 2021.

(51) Int. Cl. B60J 1/00; B60J 1/20

(52) U.S. Cl. CPC B60J 1/002; B60J 1/20

(57) ABSTRACT

The present disclosure provides a system and a method to deliver (irradiate) energy and defrost the surface of a glazing that does not require printed conductors, embedded wires, bus bar or conductive film. The present disclosure uses the optical phenomenon known as Frustrated Total Internal Reflection (FTIR) to deliver light energy directly to a surface of at least one glass layer of a windshield, glazing or other transparent substrate by means of high intensity light. The light is injected into the surface of at least one glass layer of the glazing at an angle that allows for light propagation via Total Internal Reflection (TIR). The light energy can be used as the sole source of energy or be complementary to a conductive coated resistive heated circuit and/or hot air blowing system.

### FIELD OF THE DISCLOSURE

The disclosure relates to the field of glazing, more specifically, to the field of light outcoupling materials.

### BACKGROUND OF THE DISCLOSURE

While conductive coated heated automotive windshields have been in use since at least the 1980s, it is rare to find a new vehicle on which a heated windshield is even offered as an option. This is largely due to the numerous drawbacks of the prior art, their cost, performance, and the marginal utility. However, recent industry trends are likely to increase the demand and utility for such windshields.

One major trend to emerge in the automotive industry over the last few decades, and one which has been rapidly accelerating in recent years, has been the development and introduction of hybrid electric and fully electric vehicles. This trend has been driven by concerns over the environmental impact of burning fossil fuels and the resulting regulatory requirements that have been implemented to mitigate and minimize their effect addressing these concerns.

Driving in hot or cold weather in particular, where the traction battery was required to heat and cool the cabin would substantially and rapidly reduce the range. Likewise, keeping the glazing clear of ice and snow on cold days was a major drain on the battery.

The potential of being stranded with a dead traction battery led to what has come to be known as “range anxiety”. This perceived drawback was a major roadblock to widespread adaptation by the public and continues to be a concern of consumers.

Range anxiety was one of the reasons that hybrid electrics were developed. With the battery charged by an internal combustion engine, there was no need for stationary plug-in charging and the vehicle could be quickly refueled.

Lithium-ion batteries were the breakthrough technology that enabled fully electric vehicles to be built with a range considered adequate by most drivers. The energy density of lithium-ion batteries has been going up as the price has been going down.

This has enabled production of vehicles with a battery capacity large enough to give the vehicle a driving range comparable to fossil fuel powered vehicles. In fact, battery cost and capacity has improved to the point where large, heavy duty, long range, over the road, fully electric vehicles are now being developed and fully electric delivery vehicles, which must operate for an extended period between charges, are becoming common place.

Still, cold weather driving remains a problem for fully electric vehicles due to the high energy requirements of the heating means used to clear the glazing and warm the interior of the cabin.

The two heating means commonly employed to clear the glazing are hot-air systems and resistive heating systems. Resistive heating may take the form of a wire, conductive ink or conductive coating heating circuit integrated with the glazing.

Resistive heating, also known as, Joule, resistance, or Ohmic heating, is the process by which heat is produced when electric current passes through a conductor. The power generated equals the product of the resistance in ohms and the square of the current in amperes or the product of the voltage and the current and is measured in watts.

Some improvements have been made, to reduce the energy demand during cold weather driving, which can be found on both internal combustion engine and fully electric vehicles. Heated and ventilated seats allow for greater comfort without having to change the air temperature of the entire cabin. Low-e coatings on glass roofs make for more comfortable driving in cold weather. Many HVAC systems allow for separate control of the passenger, driver, and rear area temperature. Still though, keeping the driver and passengers comfortable and the glazing clear requires a high level of power.

This is not an issue so much with vehicles powered by internal combustion engines which make very limited use of resistive heating circuits. This is because the typical internal combustion engine is very inefficient. Most of the energy from the fuel is turned into heat rather than kinetic energy. As a result, the heater core, used to exchange heat between the engine and the vehicle interior, will typically have a capacity of 4,000 watts. To put this number into perspective, a handheld electric hair dryer is usually rated at no less than 1,600 watts and the heating elements on an electric range draw from 1,200 to 2,400 watts.

The primary drawbacks to using the waste heat for heating the interior and defrosting the windows is the time that it takes for the engine to warm up and the very inefficient heat transfer to the glazing of the hot air. In some cold climates, small displacement, high efficiency, internal combustion engine powered vehicles must be equipped with resistive heating circuits to supplement the engine waste heat hot air blower system. So, we may see an increase in the use of resistive heating in internal combustion engine powered vehicles as well as fully electric ones.

A problem when adding large resistive heating electrical loads is electrical system capacity. The typical 12-volt nominal vehicle electrical system is equipped with an alternator that can provide 600 watts at idle and perhaps double that at high rpm.

While there are higher power capacity alternators, they tend to be expensive and are not used unless necessary. They are generally only found on commercial vehicles and on expensive, high end, luxury vehicles.

Further adding to the problem, the trend in the industry has been to convert accessories, such as the power steering, air conditioning and water pump, over to electrical power rather than mechanically coupling the power of the engine to drive the loads. This improves efficiency by eliminating the mechanical transmission of power and more importantly by only drawing power when the load is needed.

With a fully electric vehicle, there is no other option but for all of the accessories to be powered electrically including those that heat the cabin and defrost the windows. While there is some waste heat generated by the traction battery, the quantity is not enough to warrant the extra weight and cost that would be required to utilize it.

Resistive defroster circuits have long been used to clear the rear window in vehicles of snow, ice, and fog, due to the engine typically being in the front of the vehicle making it expensive and difficult to divert hot air to the rear window.

Electrical resistive rear defrosters are made by printing a conductive ink on the glass. The circuit is powered by the 12-volt nominal electrical system. The conductivity of the ink is high enough to allow for sufficient power to be drawn at the standard 12-volt nominal automotive system voltage.

A big advantage of this screen-printed circuit is that power density can be precisely controlled by varying the line width, thickness, spacing, and conductivity of the ink. Plus, only the area that is needed for vision can be cleared. A typical rear window only has one half to two thirds of the surface area printed with the defroster circuit so that not much more than the area that is needed by the rearview mirror is cleared. The circuit can be configured so that the central portion will clear before the areas outside of the central portion to make more efficient use of power.

As a result, the power required by a rear window defroster is usually under 200 watts and often under 150 watts. The power required to keep a rear window clear is less than would otherwise be required because of its' rear facing position and lower convective losses.

In addition to heated rear windows, resistive heated windshields have also been in production for several decades. There are two types of electrically heated windshields, transparent conductive coated and embedded wire. Printed silver lines are visible and as a result cannot be used to heat the vision areas of a windshield although they are often used to defrost the wiper rest area and the safety camera field of view.

The windshield plays an important part in the safety of the occupants of the vehicle. It is extremely important to be able to rapidly clear the windshield of snow and ice. While a vehicle can be driven with the rear window not completely clear, it is extremely dangerous to do with a windshield that is not clear of snow and ice. It is also undesirable to let the vehicle sit with the engine running for an extended period while the engine warms up and the windshield clears.

Safety system cameras, need a high, forward looking, field of view making the windshield the ideal location to mount the cameras. The windshield is an essential optical component of camera-based safety systems. The camera field of view also needs to be rapidly cleared and kept clear of ice and snow.

In addition to the time that it takes for the engine to warm up, one of the other major drawbacks to hot air systems is that as the system blows heated air across the windshield most of the energy is wasted heating the cabin rather than the windshield.

The small percent of the energy from the hot air transferred to the glazing must be transferred by conduction through the thickness of the windshield and then to the ice. Glass and plastic are both poor thermal conductors further hampering the process. In addition, hot air windshield defrosters clear from the bottom up as the vents are located at near the bottom of the windshield.

A resistively heated windshield is several times more efficient than a hot air blower system giving it the potential to clear much faster and with far less power. By placing a resistive heat source inside of the laminated windshield, the heat is delivered directly to the glass. Only the convective losses from the interior surface heat the cabin whereas the majority of the energy from a hot air defroster does. The heat is generated closer to the ice as the heat source is in the middle of the laminate. The resistive heating element is typically in contact with surface two of the outer glass layer placing the heat source one glass thickness away from the ice.

Heating begins immediately rather than after the engine has warmed up. This reduces the time that the vehicle must sit while the glazing clears. Likewise, the safety camera system will be cleared and able to operate much sooner.

Still though, while a resistive heated windshield is far more effective than a hot-air blower system we must heat several kilograms of glass and plastic along with the water and ice. Further, as the glazing is cleared, heat is still delivered to the areas already cleared which no longer need the heat.

With internal combustion engine vehicles, allocating enough electrical power to clear the glazing by means of resistive heating has been an issue. While a rear window may require under 200 watts, a windshield typically requires much more due to its forward-facing direction, installation angle, and larger surface area. Adding to the problem is that the rear window and the windshield both need to be cleared at the same time.

A typical heated windshield specification requires the circuit to be able to clear at least 80% of the vision area of 0.5 mm of ice, in 20 minutes, at a temperature of −20° C.

With a windshield, convective cooling results in losses of approximately 3 watts per square meter per major surface per degree C. Starting at −20° C., losses will be 2*3*20=120 watts per square meter. At a power density of 120 watts per square meter, the temperature would slowly rise to 0° C. and remain there. In actual practice, more power would be needed as the circuit is not isothermal. More is needed if any ice or water is present. The lowest practical power density that can meet the specification is at least 400 watts per square meter and that would be on a near vertical thin rear window. Most circuits are designed for at least 500 W/m² and some go as high as 800 W/m². Thicker glazing requires more power as does laminated glazing.

So, as we have established, a windshield that has an area of one square meter requires somewhere between 400 and 800 watts of power. However, the typical alternator only puts out 600 watts for the entire vehicle.

One approach to this lack of power has been to divide the circuit into two separate areas. This allows each half to be powered at double the power density what would be available for the entire windshield. If, as an example, if only 300 watts is available and we have a one square meter windshield, the power density with the entire windshield powered is 300 W/m² and the temperature will barely reach 0° C. if starting from −20° C.

The ice will take a very long time to melt if it ever does. If we only power half of the windshield, the 300 watts give us a power density of 600 W/m². Half of the windshield can be cleared in a reasonable amount of time and then the power can be switched to the other side. Once clear, the power can be switched back and forth to keep the glass above freezing.

When this is not desirable, a larger alternator must be provided which can produce the power needed. The alternator may also need to be liquid cooled as well.

The traction battery of a fully electric vehicle has more than enough battery capacity to power a heated glazing drawing more than 600 watts. But the problem is that the traction battery operates at a voltage that is far higher than is safe for heated glazing where there is always the potential for human contact. In fact, the traction battery voltage is too high for most of the other vehicle electrical loads as well. Typically, a DC-DC converter is used to step down the traction voltage to that of the accessory distribution bus. This may be 12, 24, 42, 48 V or some other voltage.

The same type of DC-DC convertor has been used in internal combustion engine vehicles to power transparent conductive coated heated windshields. An important difference is that the DC-DC convertor, in a fully electric vehicle, is required and thus is standard equipment as it is needed used to power all of the accessories. With an internal combustion engine vehicle, a DC-DC convertor is only needed if the vehicle has a conductive coated windshield making it a much more expensive option.

Most of the resistive heated windshields that have been produced have been made by embedding thin tungsten wires in the plastic interlayer used to bond the glass layers of the windshield together. The wire diameter and spacing is limited by optical considerations as the wires are opaque and, in the drivers' primary vision area. The opaque wires reduce the visible light transmission of the windshield. The wire diameter must be no greater than 40 μm, preferable no greater than 20 μm so as to render them invisible for all practical purposes. The minimum wire to wire spacing is ˜2 mm. As a result, this type of windshields tends to have a relatively low power density due to the high resistance of the thin wire.

Even with wires that are less than 20 μm, under certain lighting conditions, the wire can interfere with vision especially at night. To minimize this undesirable effect, the wires are typically embedded in a sinusoidal pattern. Still, drivers have complained eye strain and headaches.

Another drawback to embedded wire heated glazing is that it is prone to optical distortion when initially powered. PVB interlayer has a refractive index that is temperature dependent. If the embedded wires are spaced too far apart or not making good contact with at least one of the major glass surfaces, distortion will result. Therefore, it is important to minimize temperature gradients in the plastic interlayer over short distances.

Embedded wire defroster circuit laminates tend to be expensive to produce requiring high labor and high direct material costs to produce. Wire embedding machines are expensive, require a clean room and take up a lot of floor space.

Electrically heated transparent conductive coated automotive windshields have been available since at least the 1980s. While the optical properties of the coated heated windshield are clearly superior to the embedded wire versions, they have not been widely adapted. Part of the issue has been cost. While the windshield itself is not substantially more expensive to produce than an embedded wire version, additional electrical components are typically needed to power the windshield. This is because most coated resistive circuits, having too high of a resistance to operate at 12 volts, require a voltage convertor.

In addition to the disadvantage of the added weight and cost of a voltage convertor, the convertors tend to be electrically noisy. While the convertor itself can be shielded, the windshield that it is connected too cannot. The conductive coating will act as an antenna. To prevent interference the output of the convertor must be filtered to eliminate any electrical noise.

In addition, the transparent multi-layer conductive coating, as required for electrical resistive heating, is highly reflective in the infra-red (IR) wavelength range. While this is a desirable solar property in warmer climates, in many regions of the world it would be preferable to be able to utilize the heat of the sun to warm the vehicle interior.

The transparent conductive coating, used as the resistive heating element, is comprised of very thin layers of silver. Normally, when silver is applied to a glass substrate, it creates a mirror. By depositing alternating layers of silver and dielectric compositions, the silver can be made transparent to visible light. However, there are limits as to how thick the silver layers can be made. Visible light transmission through a windshield must be at least 70% to meet regulatory requirements. We can deposit more silver by dividing the silver into multiple silver layers. A coating with two silver layers will have visible light transmission that is higher than a coating with one silver layer that is as thick as the two layers combined. The same applies to coatings with three and four layers of silver. We can increase the conductivity of the coating by increasing the total thickness of the silver layers while holding visible light transmission above 70% by depositing the silver in multiple layers.

For very thin conductive materials we typically characterize the resistance in terms of the sheet resistance. The sheet resistance is the resistance that a rectangle, with zero resistance bus bars on opposite sides, would have. Sheet resistance is specified in ohms per square. This is a dimensionally unitless quantity as it is not dependent upon the size of the rectangle. The bus bar to bus bar resistance remains the same regardless of the size of the rectangle.

Coatings with two silver layers have a sheet resistance in the range of 2-4 ohms/sq.

For a rectangle, with the bus bars running along the long sides, the bus-to-bus resistance is equal to the width over the height times the sheet resistance.

As an example, if we have a windshield with a double silver layer coating with a resistance of 2 ohms/sq, a bus bar separation distance of 700 mm and a bus bar length of 1200 mm each, the bus-to-bus resistance, assuming that the resistance of the bus bars is insignificant, is 700/1200*2=1.17 ohms. At 13.5 volts, the nominal alternator voltage, the power will equal 156 watts. With an area of 0.84 square meters, the power density is 186 W/m², far less than what is required to clear ice and snow.

By adding an additional third silver layer, we can get the sheet resistance down to 1 ohm/sq but the power density is at 372 W/m² still less than the minimum of 400 W/m². Heated windshields made with single, double, and triple silver coating have been produced but all required voltage converters in order to get the power density up to the level required to effectively deice the glazing in a reasonable length of time.

A means used to meet the requirements without a voltage convertor has been to add a fourth silver layer to the solar-control stack, thus reducing the total sheet resistance. This, however, comes at a substantial cost.

There is a technical tradeoff between the level of visible light transmission and the sheet resistance. Reducing the sheet resistance results in a decrease in visible light transmission. This is a consequence of an increased interaction of impinging photons with an increased concentration of oscillating free electrons in solar-control coatings with a lower sheet resistance.

There is only a marginal improvement in solar control performance from the additional silver layer needed to reduce the sheet resistance to below 1.0 ohm/sq. The solar control properties of silver coatings reach the point of diminishing return at three layers. A three-layer coating is a near perfect filter with a sharp cutoff that allows visible light to pass while reflecting most of the light in the IR wavelength range. The fourth silver functional layer of the prior art is almost exclusively used for the sake of meeting the voltage/dissipating power requirements associated with the use of 12-16 V electric systems rather than improving the solar performance. The slight improvement in solar properties gained with the addition of the fourth silver layer does not offset the added cost.

It is possible to reduce the sheet resistance to as low as 0.6 ohms/sq with a fourth silver layer. At this level the bus-to-bus resistance of our example windshield drops to 0.35 ohms and the power density increases to ˜620 W/m² at which point performance is comparable to a hot-air blower system. At −20° C., the windshield will require 520 watts.

If the same vehicle without a heated windshield was equipped with a 600-watt alternator, it will have to be increased to one that can provide 1,100 watts. The windshield will draw the full 520 watts only briefly. By the time that the windshield reaches 0° C., the power will drop to 440 watts.

Several quad silver coated windshields sampled from current series production have been analyzed and found to have power densities in the range of 400 to 500 W/m². At this level, the defroster must be supplemented by a hot-air system.

Perhaps the biggest drawback to this approach, from a manufacturing standpoint, is that quad silver coatings cannot be made on many existing production coaters.

Large, high throughput, MSVD coaters are complex machines requiring capital investments in the 10s of millions of dollars as well as a team of highly skilled operators, technicians, and engineers.

Depositing an additional silver functional layer along with the supporting adjacent dielectric layers imposes additional processing requirements. As the glass passes through the coater, material is deposited from various targets. Each layer of the coating added requires additional targets. As we add layers to the coating stack, the length of the coater, footprint, and operating cost increase dramatically. This understandably results in a substantial increase of capital expenses and an elevated cost of consumable materials, maintenance, and consumed energy.

Many coaters purchased to produce single, double, or triple silver coatings do not have the capability to produce a coating with four silver layers without major modifications and a major investment. Even when the coater is large enough to deposit all of the layers of a quad silver coating it may not be possible to do so with many of the older existing coaters built using the older technology. As the layers get thinner, it becomes increasingly difficult to hold the nano-meter tolerances of the layers leading to higher rejection rates.

In addition to the manufacturing issues, the design of the heating element can be difficult. Some areas of the glazing may require that the coating be removed or not deposited.

Silver is a highly reactive element. When exposed to air and water it will react forming non-conductive compounds. To protect the silver, from the environment and prevent this corrosion, the outboard edge of the coating is limited to no less than 6 mm from the edge of glass. This is accomplished by masking the glass prior to coating or by deleting the coating after it has been applied. We shall refer to such areas as deletions.

Deletions are also required to allow for the use of cameras, rain sensors and RF devices inside of the vehicle. The conductive coating blocks radio frequencies preventing in-dash mounted GPS and similar devices from functioning. As the coating is designed to reflect infrared light, it will interfere with optical rain sensors. The coating also can cause a color shift and lower light transmission causing problems for safety camera systems. These deletion areas without coating will disrupt the flow of current. We tend to see hot spots above and along the sides of the deletion areas and cold spots below.

For uniform heating the bus bars need to have a constant separation distance and be of the same length. If the windshield is not a rectangle, the heating will not be uniform. Unfortunately, few automotive windshields have a rectangular shape. Most tend towards a trapezoidal shape with the top edge being shorter than the bottom edge. Also, the length of the vertical centerline tends to be greater than the vertical distance from the top and bottom corners. This causes wide variations in the bus-to-bus resistance along the bus bar and corresponding variation in power density and temperature. A typical windshield, as described, will run hotter along the top and sides (such as in the A pillar regions) than along the bottom.

The bus bars themselves often are another source of unwanted heat as bus bars must often be undersized for the current flow due to the limitations of the lamination process and the black obscuration available to hide the bus bars. It is not unusual to have heated areas that still have ice while other parts of the heated area are above 60° C. These large thermal gradient stress the glass and can result in premature breakage.

Another problem is that while a vehicle with a broken windshield can still be operated and may not require immediate replacement of the windshield this is not the case when a conductive coated heated windshield breaks. If the conductive coating of a heated windshield should develop even a small break, the disruption in the current flow can create a hot spot which can potentially result in injury or fire. The crack can also create an electrical hazard by leaving the conductor exposed.

At the higher voltages available in a fully electric vehicle, we have somewhat of the opposite problem of what we have with a 12 V system. With one, two, three or four silver layers, the resistance for any single coating stack will always remain within a certain narrow range. Likewise, the bus bar layout is constrained by the shape of the glazing and the black obscuration. Thus, the bus-to-bus resistance of any transparent conductive coated heated windshield will be limited by the actual windshield shape and the coating selected. There is very little that can be done to fine tune the resistance if we need to target a specific power density at a fixed voltage.

Looking at the 700 mm×1200 mm of our previous example, at 42 V, with a double silver, 2 ohm/sq coating, the power density is 1,800 W/m², with a triple silver 1 ohm/sq coating, the power density is 7,200 W/m² and with a quad silver, 0.5 ohm/sq coating the power density is 12,000 W/m². These power densities are far too high. The glazing would likely break from the thermal stress. At 42 V, we would need to have a sheet resistance of 6 ohms/sq to get a power density of 600 W/m². While a single or double silver layer could be developed, it would require thinner silver layers and likely have poor solar performance. A new coating would need to be developed for every new windshield with a different shape and power requirement.

Another issue is that coated glass is made based upon the optical properties of the coating, not the electrical. While the color and other optical properties are controlled within a tight tolerance, the electrical conductivity can vary. If we add an electrical tolerance, on top of the other parameters, reject rates and the production cost will increase.

It is difficult to optimize a coating for heat resistance, solar performance, visible light transmission and transmitted and reflected color. For years, the early solar coated windshields were plagued by complaints about the reflected pinkish/rose color. If sheet resistance is added, the task becomes near impossible. The sheet resistance can be shifted by doping the conductive layers and by changing the thickness. Both methods will cause the other properties to shift as well and almost always in an undesirable direction. Even holding the sheet resistance to a narrow tolerance is difficult.

Another drawback, common to all resistive heating circuits, is the positive temperature coefficient of resistance of the heating elements. As the temperature increases, the resistance increases and the power decreases. It would be preferable to have the circuit draw full power until no longer needed. From −20° C. to 20° C., the resistance of a silver-based circuit will increase by 15% as the power drops by 15%. Values for printed silver, copper wire, and tungsten wire are similar.

Another source of inefficiency is that once the ice starts to melt and clear, whether the glazing is heated by a hot air system or is resistively heated the system will continue to heat the cleared area even though it is no longer needed.

The demand for electrically heated windshields has been growing and is expected to accelerate as energy efficiency and a short drive-away time become more important. At the same time, some of the constraints that have limited adaptation, are going away. It is expected that the industry will migrate to a higher system voltage which will further facilitate growth. Sufficient power will no longer be a constraint with the large capacity of the traction batteries on fully electric vehicles.

Still, issues remain which include the inability to fine tune the resistance of the circuit to match a specific voltage and windshield shape, the high capital investment to upgrade or buy a coater, interference with radio waves, hot and cold spots from deletions, need to heat the entire mass of the windshield in addition to the snow and ice, and the energy wasted by heating areas already cleared.

In the field of photovoltaic solar cell and concentrated solar cells there is also an urgent need for finding a low-power solution to melt the ice or snow accumulated on surface of the panels during cold nights or due to snowstorms instead of relying on the precious hours of sunlight that should firstly melt the ice/snow before the sunlight can start to be collected and converted into electricity.

US 2017/0013679 publication discloses a windowpane system comprising: a windowpane; and at least one primary light source being arranged so that light from the primary light source passes into the windowpane through a first surface of the windowpane, the light then travelling within the windowpane until it has undergone total internal reflection from one or more surfaces of the windowpane a plurality of times, wherein at least some of the light from the primary light source is absorbed by the windowpane as the light passes through the windowpane. Nevertheless, this disclosure emphasizes in light absorption and/or heating of the glass.

It would be desirable to have a glazing that did not have the drawbacks of the prior art.

### BRIEF SUMMARY OF THE DISCLOSURE

The disclosure provides a system and a method to deliver (irradiate) energy and defrost the surface of a glazing that does not require printed conductors, embedded wires, bus bar or conductive film. The present disclosure uses the optical phenomenon known as Frustrated Total Internal Reflection (FTIR) to deliver light energy directly to a surface of at least one glass layer of a windshield, glazing or other transparent substrate by means of high intensity light. The light is injected into the surface of at least one glass layer of the glazing at an angle that allows for light propagation via Total Internal Reflection (TIR).

The light energy can be used as the sole source of energy or be complementary to a conductive coated resistive heated circuit and/or hot air blowing system. By controlling the injection angle to be no more than the critical angle, the light is outcoupled of the glazing and the energy is delivered to the areas of the glazing with snow/ice and/or water rather than areas that are clear and dry where the energy is not needed.

The glazing system comprises at least one glass layer, at least one lighting means configurated to inject light at an angle relative to the major surface normal of the glass layer. The injection angle should be greater than or equal to the critical angle of the glass/air interface and less than or equal to the critical angle of glass/snow-ice. The intensity of the injected light is of at least 20, or preferable at least 40, or preferable at least 50, or preferable at least 70, or preferable at least 90, preferable at least 100 W/m²; or preferable at least 150; or preferable at least 200.

The method of delivering energy (irradiating) the glazing consists of firstly scanning and determining the glazing surface condition and lastly injecting the light into the glazing no more than the critical angle calculated for the snow/ice mix contaminant on the glazing at a minimum power intensity of 100 W/m². The determination of the glazing surface condition is performed by the steps of scanning the glazing surface to create a baseline map and subsequently scan periodically the glazing so the surface condition maps may be compared with the baseline and with each other. Additionally, the method may comprise the step of activating clearing mechanisms such as turning on wipers, air conditioning or cabin heating systems.

The system and method of the disclosure may be able to reduce the power required by at least ⅓ or given the same power reduce the time to clear by at least ⅓ as compared to resistive heating.

### Advantages

Optimize solar and optical performance independent of heated circuit;
Meet power dissipation requirement regardless of supply voltage;
Optimal power dissipation from a fixed-voltage electric system for windshields with different dimensions, configurations, and separation distances between bus bars;
Avoid hot spots and cold spots;
Defrost areas with coating deletions;
Particularly advantageous for glazing having with coatings and safety cameras;
Avoid arcing;
Eliminate temperature dependency of resistive circuits;
Increase safety of automotive glazing;
Eliminate potential for electrical hazard;
Does not require high voltage alternator;
Does not require a voltage convertor;
Transparent conductive coating is not required;
Far higher energy efficiency than hot air systems;
Higher energy efficiency than resistive heating systems;
Compatible with any kind of glass strengthening method such as thermal or chemical strengthening;
Compatible with several types of functional coatings such as anti-reflection, anti-fingerprint, and hydrophobic as well as solar protection coatings;
Compatible with several types of functional interlayers such as tinted or UV-blocking interlayers;
Capability to customize irradiation pattern;
Capability to dynamically modify irradiation pattern;
Capability to sense areas not cleared and target them;
Lower cost of replacement glazing.

### BRIEF DESCRIPTION OF THE DRAWINGS

FIG. 1A shows the cross section of a typical laminated automotive glazing.

FIG. 1B shows the cross section of a typical laminated automotive glazing with performance film and coating.

FIG. 1C shows the cross section of a typical tempered monolithic automotive glazing.

FIG. 2 shows a schematic of the Total Internal Reflection phenomenon.

FIG. 3 illustrates one embodiment of the disclosure showing a windshield with top and bottom edge coupled in light injection defrosting and detectors.

FIG. 4 illustrates one embodiment of the disclosure showing a windshield with top and bottom surface four coupled in light injection defrosting and detectors.

FIG. 5 illustrates one embodiment of the disclosure showing a windshield with transparent conductive heating and edge coupled in light injection heating.

FIG. 6 illustrates one embodiment of the disclosure showing a windshield with transparent conductive heating and top and bottom surface four coupled in light injection heating for deletion area.

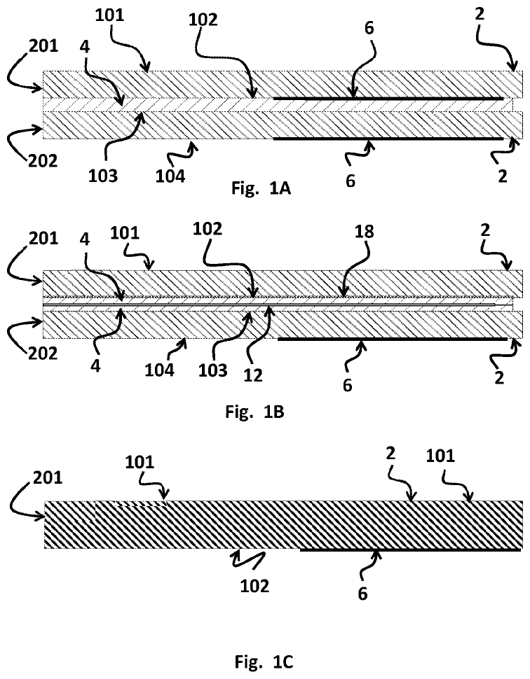

### REFERENCE NUMERALS OF DRAWINGS

2 Glass.
4 Bonding/Adhesive layer (plastic Interlayer).
6 Obscuration/Black Paint.
12 Infrared reflecting film.
18 Infrared reflecting coating.
20 Light injection assembly.
22 Detector.
24 Processing Unit.
30 Material one.
32 Ray one.
34 Angle one.
40 Material two.
42 Ray two.
44 Angle two.
46 Major surface normal.
50 Coating deletion.
52 Bus Bar.
101 Exterior side of outer glass layer 201, number one surface.
102 Interior side of outer glass layer 201, number two surface.
103 Exterior side of inner glass layer 202, number three surface.
104 Interior side of inner glass layer 202, number four surface.
201 Outer glass layer.
202 Inner glass layer.

### DETAILED DESCRIPTION OF THE DISCLOSURE

The present disclosure can be understood more readily by reference to the detailed descriptions, drawings, examples, and claims in this disclosure. However, it is to be understood that this disclosure is not limited to the specific compositions, articles, devices, and methods disclosed unless otherwise specified, as such can, of course, vary.

It is also to be understood that the terminology used herein is for the purpose of describing aspects only and is not intended to be limiting.

The following terminology is used to describe the laminated glazing of the disclosure.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

Laminates, in general, are articles comprised of multiple layers of thin material, relative to their length and width, with each thin layer having two oppositely disposed major faces, typically of relatively uniform thickness, which are permanently bonded to one and other across at least one major face of each layer. The layers of a laminate may alternately be described as sheets or plies. In addition, when the laminates include glass layers, those may also be referred to as panes.

The term “glass” can be applied to many inorganic materials, including many that are not transparent. For this document we will only be referring to transparent glass. From a scientific standpoint, glass is defined as a state of matter comprising a non-crystalline amorphous solid that lacks the long range ordered molecular structure of true solids. Glasses have the mechanical rigidity of crystals with the random structure of liquids.

The types of glass that may be used include but are not limited to the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

Soda-lime glass is made from sodium carbonate (soda), lime (calcium carbonate), dolomite, silicon dioxide (silica), aluminum oxide (alumina), and small quantities of substances added to alter the color and other properties. Certain types of organic transparent materials are used to produce automotive and other types of glazing which would not, in the common meaning of the word glass, be considered glass. For the purposes of this document, we shall consider these as glass as the principle of the invention can be applied to any transparent substrate.

Windshields are a type of laminated safety glass. Safety glass is glass that conforms to all applicable industry and government regulatory safety requirements for the application. Laminated safety glass is made by bonding two layers of annealed glass together using a plastic bonding layer comprised of a thin sheet of transparent thermo plastic.

The plastic bonding layer (interlayer) has the primary function of bonding the major faces of adjacent layers to each other. The material selected is typically a clear thermoset plastic. For automotive use, the most used bonding layer (interlayer) is polyvinyl butyral (PVB). Automotive grade PVB has a refractive index that is matched to soda-lime glass to minimize secondary images caused by reflections at the PVB/Glass interface inside of the laminate. In addition to PVB, ionoplast polymers, ethylene vinyl acetate (EVA), cast in place (CIP) liquid resin and thermoplastic polyurethane (TPU) can also be used as interlayer.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic bonding layer helping to maintain the structural integrity of the glass. A vehicle with a broken windshield can still be operated. The plastic bonding layer also helps to prevent penetration by objects striking the laminate from the exterior and in the event of a crash occupant retention is improved.

The disclosure is based up the principle of Frustrated Total Internal Reflection, FTIR, which we will briefly explain.

The refraction index (RI) of a material is defined as the ratio of the velocity of light (c) in a vacuum to the velocity (v) in the material.

$$RI = c / v$$

The refractive index must always be equal to or greater than one. The more optically dense a material is, the slower light will move through the material.

Refraction occurs when the path of a beam changes as it travels from one media to another media with a different refractive index. Refraction is caused by the change in the speed of light in the media. The beam will bend at the interface. If the light slows down, it will diverge away from the surface normal. If the light speeds up, it will diverge towards from the surface normal.

The change in direction is a function of the ratio of the refractive index of the second media to the first.

When light travels from a media, with a higher refractive index to one with a lower refractive index, the light will refract and exit the denser media if the angle of the beam relative to the surface normal is less than the critical angle. If the angle of incidence is equal to or greater than the critical angle, TIR, occurs.

The critical angle is the smallest angle of incidence of light travelling in one medium and reaching the interface of an adjacent medium that is optically different (has a different index of refraction) where light suffers total internal reflection, TIR. Any light incident to the interface at a smaller angle than the critical angle, will refract to the adjacent medium.

If n₁ is the refractive index of the glazing and n₂ is the refractive index of the adjacent medium in direct contact with it such as in surface one 101 or surface four 104, then the critical angle θ_{c} is calculated by:

$${θ}_{c} = arc sin \frac{{n}_{2}}{{n}_{1}}$$

Using refractive index values of 1 for air, 1.53 for glass, 1.33 for water and 1.30 for ice, and 1.42 for contaminated snow-ice (the average between the index of contaminated snow, 1.525, from Mackenzie Skiles et al. 2016 Journal of Glaciology 63 (237), and that of ice) we get critical angles of:

$$\begin{matrix}{θ}_{glass / air} = 40.81 ° \\ {θ}_{glass / ice} = 58.18 ° \\ {θ}_{glass / water} = 60.63 ° \\ {θ}_{glass / snow ‐ ice} = 68.14 °\end{matrix}$$

We can see that the critical angle at which TIR occurs varies over a wide range depending upon the surface condition and the light injection angle.

When TIR occurs, any substance present on the surface will frustrate TIR if the substance has a refractive index that results in a critical angle that is greater than the angle of incidence of the internal light. This is the principle that the disclosure is based upon.

This is also the principle upon which fiber optics work. A glass fiber is clad in a transparent material with a low index of refraction resulting in total internal reflection at even very low angles. Not only does total internal reflection allow a single fiber cable to conduct light over a great distance, by varying the angle of incidence of the beam entering the fiber, up to 3,000 different separate beams can be simultaneously carried over the same multimode fiber.

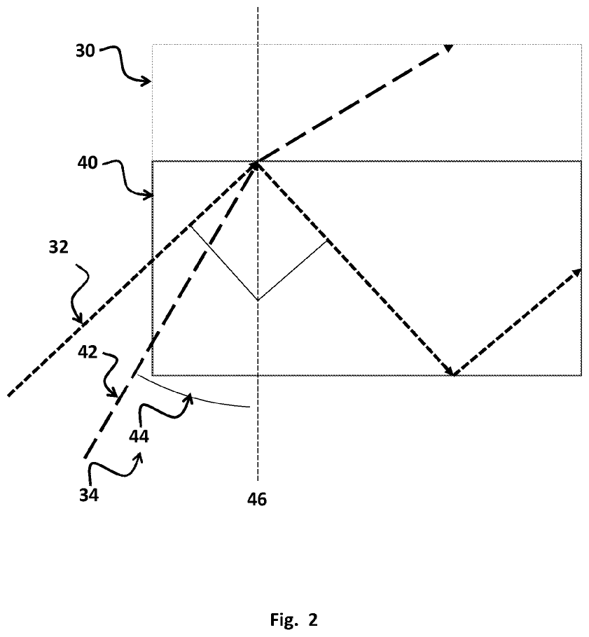

The principle is illustrated by FIG. 2. Two rays of light, ray one 32 and ray two 42 enter material one 40. Material two 30 has a refractive index of n₁ and material one 40 has a refractive index of n₂. Ray two 42 enters at angle two 44, which is less than the critical angle, and passes through material one 40 into material two 30. Ray one 32 enters at angle 34, which is equal to the critical angle, and is reflected and trapped within material one 40.

In the case of an automotive glazing where material two is the glazing (monolithic glass or layers of glass laminated between plastic bonding layer such as PVB) and material one is the material external to the glazing and in direct contact with surface one 101, if light is injected into the glazing at an angle greater than 60.63° but less than 68.14°, such as around 65°, total internal reflection only occurs in the areas of the surface that are not coated with the snow and ice mix. The light will outcouple in the snow and ice mix areas and heat the snow-ice. If the angle of injection is less than 58.18° but greater than 40.81°, the light will outcouple and heat any water, ice, or snow-ice present. In the absence of any water, ice or snow-ice, the trapped light will continue to reflect, until absorbed by the glass, heating the glass.

It should be noted that some indices may very slightly depending on the type of glass and the level of contamination of water and the snow-ice mix. For example, refractive index of soda lime glass may vary between 1.50 to 1.56. Refractive index values have a tolerance of +/−0.50; more preferably +/−0.40; more preferably +/−0.30.

The present disclosure takes advantage of this selective absorption to customize and adjust the absorption by varying the injection angle of the light. All of the light can be at the same angle, or a combination of angles may be used. It may also change the angle as needed with the appropriate optical or mechanical device. It may have some at an angle that will outcouple only in the areas with snow-ice, others at an angle that will outcouple to water and snow-ice to prevent the melted snow-ice from re-freezing.

While the focus of the embodiments and discussion is laminated automotive windshields, it can be appreciated that the disclosure is not limited to laminated automotive windshields. The disclosure may be implemented with monolithic glazing as well as any of the other glazing positions in the vehicle. In the same manner, the disclosure may be implemented in any type of glazing including glazing that is not used in a vehicle such as in commercial, military, marine, rail, aerospace and other vehicles as well as in stationary applications such as view ports, building windows, partitions, displays, lenses, sight glasses, freezer/refrigerated display cases, displays in other applications, photovoltaic solar cells, concentrated solar mirrors and others, including many which have not previously been possible to heat by any means other than hot air. Further, the disclosure may be used to irradiate any transparent material with parallel surfaces. One example would be a shaving mirror. The method of the disclosure can be used to keep a mirror free of condensation and fogging.

In addition, the heated substrate does not need to be inorganic glass. Any transparent material, including organic, can potentially be used depending upon the optical properties of the material.

Likewise, it should be noted that other lighting means may be used in place of the LEDs of the described embodiments and this disclosure without departing from the concept of the disclosure. Any means that can provide the intensity and meet the packaging requirements may be utilized including, incandescent, halogen, fiber optics, light pipes and even means not yet invented. Further, any possible combination may be used. The lighting means may comprise a light source located away from the glass and delivered to the glass by means of a waveguide. We shall refer to any and all of these as lighting means regardless of the type of light emitter and method of delivery.

Due to the high intensity of the light required, visible light is impractical as the outcoupled light would be highly visible. While any frequency and type of light may be used, near infrared works the best for a number of reasons. The lighting means emits light in the range of 780 nm to 4000 nm.

Infrared is invisible to the human vision and as a result will not obstruct the view of the driver or make surface imperfections in the glass visible, as is the case with visible light. Soda-lime glass is nearly transparent in the IR. As a result, most of the energy heats the water and ice rather than the glass and plastic of the glazing.

Finally, while infrared has lower photon energies than visible light, IR is strongly absorbed by water which has an emissivity of near 1. Water molecules have many phase transitions separated by energies on the order of 10-5 eV to 10-2 eV, well within the IR range. There are many phases in water molecules that can absorb a large range of IR photon energies.

Fog on the interior surface of glass has different optical properties than a thin film of water. We can see through a thin film of water but not fog. In fact, fog acts much like an anti-reflective coating. The droplets tend to frustrate TIR and absorb a high percentage of the IR energy.

The disclosure principle does not rely on light absorption and/or heating of the glass (substrate) for applications such as de-fogging, de-icing, de-frosting or similar. Instead, it relies on the phenomenon of outcoupling of TIR light into a more optically dense medium, e.g., snow/ice or fog. The light finds optically dense areas in the surface and outcouples then (self-controlled light outcoupling). Therefore, the effect is not caused by the heating of the substrate itself. Nevertheless, the glass surface may heat since it is being irradiated by a light source.

Energy efficiency can be further improved by using a condition detection system such as the method of convoluted mapping described by Krasnov et al. In the patent application PCT/IB2022/055677 of the same Applicant of the present disclosure, which is incorporated here in its entirety by reference, to detect the condition of the surface and switch the power on and off and/or varying the intensity and/or the angle of the light as needed. The method of scanning, detecting, triggering a solving mechanism, scanning again, and comparing with the baseline in an iterative matter until the problem is solved could be used in this disclosure, where the solved problem could be when ice, water, snow, fog is completely eliminated or removed to an acceptable degree.

While infrared light is used in all of the embodiment, the type of light emitted by the lighting means of the disclosure includes but is not limited to collimated or uncollimated, white, monochromatic, multi-wavelength light or any possible combination depending upon the application. While visible light is not appropriate for an automotive application it may be for others.

When there is snow-ice on the surface of the glazing, it frustrates TIR. The IR light is absorbed by the first few molecules of the snow-ice where the energy is absorbed. Rather than having to heat the entire mass of the snow-ice and windshield, a thin film of liquid water is formed allowing for the wiper system to remove the ice. Likewise, fog on the interior surface of the windshield is quickly removed. This allows the disclosure to clear snow-ice and fog with far less power than required by pure resistive heating. It may be possible to clear the windshield with a small fraction of the power required as we only need to heat a few microns rather than the full thickness of the glass and ice.

The lighting means can easily be turned on and off and change the intensity of each lighting means to target the areas where it is needed while the areas that are clear are no longer heated improving energy efficiency even further. This action could also be controlled by a process unit connected to the glazing. Detectors could be attached on the glazing on the opposite side of the light injection and the difference between the baseline light injected with respect to the light detected on the other end of the glazing would indicate if a frustrating element such as water, ice, snow, other contaminant is present or not and trigger the heating mechanism in specific areas as well as trigger other cleaning/clearing mechanisms such as wipers, etc.

The edge of glass may be provided with an optically coupled reflector or reflective coating to contain the energy within the glazing. In the absence of water or ice on one of the major surfaces, frustrating the TIR, the glass will absorb the energy and be heated. While soda-lime glass is transparent in the near infrared range, some of the injected light will be lost by absorption as it passes through the layers of the laminate.

Absorption is related to the iron content of the glass. A low iron, ultra-clear glass may be used. With the light trapped in the glass by TIR and the reflective edges, eventually all energy not outcoupled or leaked will be dissipated as heat in the glass. In cold weather this allows for uniform heating of the entire windshield to keep the glass above freezing and prevent the buildup of snow and ice. An IR at least partially absorbing glass composition, interlayer or coating may be added so as to facilitate heating of the glass.

We shall use the word inject to describe the process of introducing light into the glazing wherein the glazing acts as a waveguide for the light. The light injection means must generally direct the light at a specific angle or range of angles. The light injection means may be integrated as a part of a molding, frame, housing, bracket, encapsulation, or trim.

With respect to light injection, the angle of injection as discussed is the theoretical angle that a perfect single ray, traveling through a perfect optical path would make with respect to the major surface normal. In practice, all of the photons will not be at the exact angle desired, but a substantial portion will be at or within a tolerance at which the TIR will occur.

The angle of the injected light must be greater than the critical angle. This critical angle is the smallest angle of incidence at which total internal reflection occurs. The critical angle is a function of the refractive index of the two media that the light passes through.

For soda-lime glass and air the critical angle is 40.81°. At this angle or below it, the light will not outcouple and directly heat anything on the glass surface.

The snow-ice mixture on the surface of a windshield is a light-diffusing mixture of dust-contaminated crystalline ice and snow. If it were pure ice, we would be able to see through it. A number of studies have estimated that the typical index of refraction for this contaminated snow-ice in most cases is 1.42 This gives a critical angle of 68.14° for the glass/snow-ice interface.

If the light is injected at just above the glass/water critical angle but below the glass/snow-ice angle the light outcouples from the glass to the layer of snow-ice and dissipates into heat, thus melting the snow-ice. As soon as the area with ice melts, its index of refraction changes to the index of refraction of water (˜1.33), and the critical angle decreases to 60.63 degrees. This results in the light regaining its TIR properties and moving along to the next iced area and heating it, and so on. So, the light energy preferentially ‘migrates’ from the areas on the windshield where the ice already melted across the surface and toward the edge opposite to the edge with the light source. This results in the localized power density in the areas still covered with the snow-ice to have a far higher power density than the average for the whole surface. If half of the window is just wet or dry, the power density in the frozen areas will be approximately double what it would be otherwise with a resistive circuit of the same total power. Once there is a thin film of water under the ice the ice can easily be removed by the wiper system.

Some light may be injected at an angle between that of glass/water and glass/show-ice so as to keep the thin film of water from refreezing and to complete melting of the remaining snow-ice.

Further improvement can be made by placing light injection means on or near at least one edge, preferably along more than one edge, or even along one or more opposite edges so that the light beams coming from opposite directions reinforce the heating capacity. This allows for the glazing to clear from the center out rather than from the top or bottom as is the case respectively with resistive defrosters or hot air.

Light detectors connected to a processing unit can be placed along at least one edge of the glazing to enable the capability of sensing which areas need to be cleared. These light detectors and processing unit connected to the glazing could be part of a surface condition detection system. The method of heating the glazing comprises the steps of: firstly, when the glazing is first placed into service, an initial scan of the dry surface of a glazing performed by the detectors is mapped by the processing unit to create a baseline map of the surface. Subsequent scan maps are compared to the baseline and to each other to determine the glazing surface condition. The processing unit could store the information sent by the detectors and does turn on the lighting means. It additionally may control the power distribution of each light injection means and/or trigger other clearing mechanisms to improve or speed up the glazing cleaning. A few examples of clearing mechanisms are to turn on the cabin air conditioning or heating system and turn on the windshield or backlite wipers.

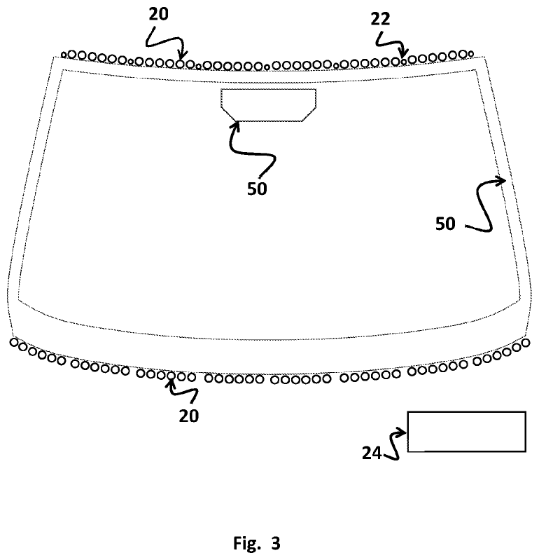

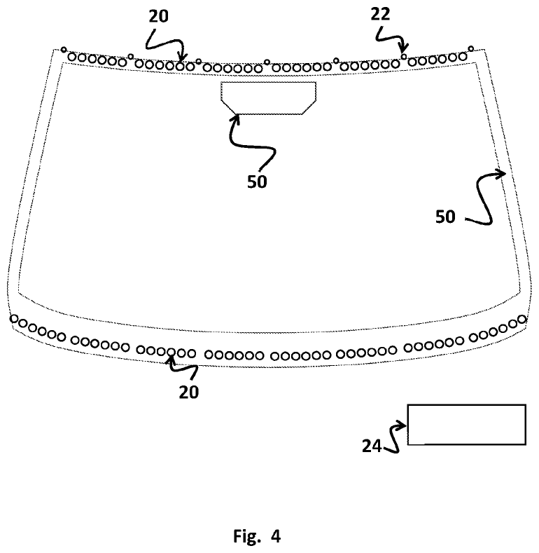

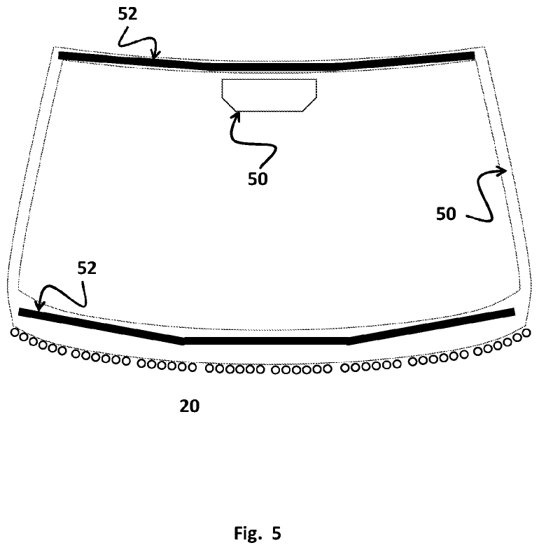

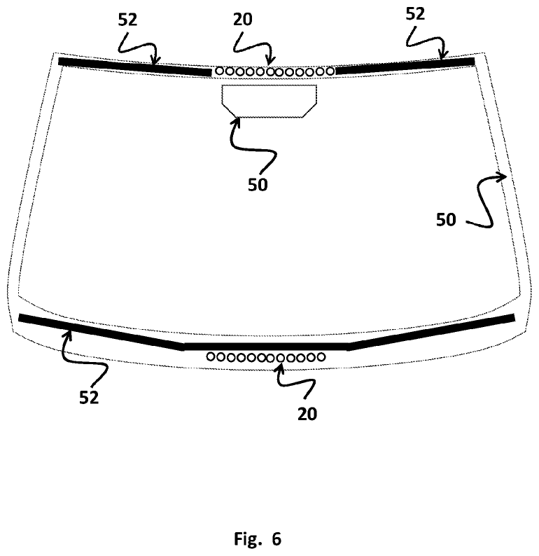

The baseline will shift given the presence of water, snow, ice. These are known as “frustrating elements”. The path of light through the thickness of the glazing is disrupted by the presence of a frustrating element on the surface of the glass. The higher refractive index of the frustrating element allows the internally reflected light to be decoupled from the glass layer and to exit the glass layer. This will lower the intensity of the light measured by the detectors. These large, convoluted data sets can be analyzed to determine if the change is from water, snow, or ice by the characteristic signature that each will produce.
1. Embodiment 1 comprises a laminated windshield as depicted in FIG. 3. The windshield has a center line height of 800 mm and a width of 1200 mm. The outer glass layer 201 is ultra-clear low iron 2.3 mm thick soda-lime glass. The inner glass layer 202 is solar green soda-lime glass. A PVB interlayer with a thickness of 0.76 mm is used to laminate the two glass layers together. A solar coating is applied to surface two 102 and an obscuration is printed on surfaces two and four. The solar coating is deleted 50 back from the edge of glass by at least 12 mm. In addition, an area near the top of the windshield is also deleted 50 to allow for electronic devices such as a rain sensor and two cameras.
   An array of thirty-six, LED based, light injection assemblies 20 is installed along the top edge and forty-eight along the bottom edge of the windshield. The light is coupled into the glazing along the edge of the glazing.
   The light injection assemblies 20 produce light in the near IR range, are 85% efficient and draw 8 W each of electrical power. The total electrical power required is 672 W and the total output of energy is 570 W with 100 W of waste energy dissipated along the edges. The power density is 600 W/m².
   The LEDs of the light injection assemblies 20 are powered in groups. Each group is sized to allow the group to operate at the vehicle DC bus voltage of 13.5 volts with 6 LEDs in series in each group. By increasing the number of LEDs in series in each group higher voltages can be used.
   The light injection assemblies 20 are optically coupled to the glass edge such that the incident angle, relative to the major surface normal is between 60.63 and 68.14 degree.
   Seven light detectors 22 are spaced along the top edge. The detectors 22 measure the intensity of light. A baseline set of values is measured and saved with a clean dry windshield. By comparing the baseline to the measured current values, the state of the glazing can be estimated. A processing unit 24 is used to analyze the data and control the intensities of the groups as well as to switch groups on and off. In this manner, power is only applied where needed.
2. Embodiment two, shown in FIG. 4, is based upon the same windshield as embodiment one. The light injection assemblies 20 however, are mounted to and optically coupled to the surface four 104 of the glass. The coating is deleted 50 from the edge of glass to just outboard of the black obscuration to allow for the injected light to enter the outer glass layer 201 as well as the inner glass layer 202.
3. Embodiment three, shown in FIG. 5, is based upon the same windshield as embodiment one. In this embodiment, conductive bus bars 52 have been added running across the top and bottom of the windshield to provide for resistive heating. The resistive heating is supplemented by a set of light injection assemblies 20 mounted along the bottom edge of glass.
4. Embodiment four, shown in FIG. 6, is based upon the same windshield as embodiment one. In this embodiment, conductive bus bars 52 have been added running across the top and bottom of the windshield to provide for resistive heating. The resistive heating is supplemented by two sets of six light injection assemblies 20 mounted along both the top and bottom edges at the center of the windshield. The large deletion for the camera 50 near the top disrupts the flow of current through the conductive coating. The top bus bars 52 are cut back from the deletion 50 to minimize the tendency for hot spots to form due to the current being interrupted by the deletion. To make up for the lack of resistive heating the light injection heats the camera deletion and the area under which would otherwise run cold.
5. Embodiment five is based upon the same windshield as embodiment 1 with the exception that the incident angle of the light injection assemblies 20 relative to the major surface normal is between 40.81 and 58.18°.
6. Embodiment six is based upon the same windshield as embodiment 1 with the exception that the incident angle of half of the light injection assemblies 20 relative to the major surface normal is between 60.63 and 68.14° and the other half of the light injection assemblies 20 relative to the major surface normal is between 40.81 and 58.18°.

What is claimed is:

1. A glazing system, comprising:
at least one glass layer;
at least one lighting means configured to injecting light from said at least one lighting means into said at least one glass layer at an angle relative to the major surface normal of said at least one glass layer;
wherein the injection angle is greater than or equal to the critical angle of the glass/air interface and less than or equal to the critical angle of glass/snow-ice.

2. The glazing system of claim 1, wherein the angle of the injected light, relative to the major surface normal from said at least one light injection means, is greater than the critical angle for glass/water but less than the critical angle of glass/snow-ice.

3. The glazing system of any one of the preceding claims, wherein said at least one lighting means emits light in in the range of 780 nm to 4000 nm.

4. The glazing system of any one of the preceding claims, wherein said light means configured to injecting light distributed along and optically coupled to the glazing on or near at least one edge.

5. The glazing system of claims 1 to 3, wherein said light injection means is optically coupled to at least one major surface of the glazing.

6. The glazing system of any one of the preceding claims, wherein the glazing further comprises a resistive heating circuit.

7. The glazing system of any one of the preceding claims, wherein the glazing system further comprises a surface condition detection system.

8. The glazing system of claim 7, wherein the surface condition detection system comprises at least one surface detector and at least one processing unit wherein the surface detector is connected to said processing unit.

9. The glazing system of claim 8, wherein the processing unit is configured to perform at least one of the following:
scan the dry surface of the glazing by means of said at least one detector and store the information creating a baseline map of the glazing surface;
scan periodically the glazing surface by means of said at least one detector and create maps of each scan that are compared to the baseline and to each other to determine the glazing surface condition; and
turn on at least one lighting means for injecting light into the glazing.

10. The glazing system of claim 9, wherein the processing unit is also configured to trigger at least one additional clearing mechanism selected from the group of:
controlling the power distribution of said at least one lighting means based upon the glazing surface condition;
turning on the wipers; and
turning on the air conditioning or heating system.

11. The glazing system of any one of the preceding claims, wherein light is injected at more than one angle.

12. The glazing system of any one of the preceding claims, wherein the glazing system further comprises an IR at least partially absorbing layer.

13. The glazing system of any one of the preceding claims, is an automotive windshield, roof or backlite.

14. The glazing system of claims 1 to 13, is an autonomous vehicle glazing, electric vehicle glazing, conventional automotive glazing, architectonic window, appliance door, photovoltaic solar cell, concentrated solar mirrors, or display.

15. The glazing system of any one of the preceding claims, further comprising a solar control coating.

16. The glazing system of any one of the preceding claims, further comprising a safety camera connected to one of the major surfaces of the glazing.

17. The glazing system of claim 1, wherein the intensity of the injected light is at least 100 W/m².
